(19) United States
(12) Patent Application Publication
(10) Pub. No.: US 2006/0163936 A1
(43) Pub. Date: Jul. 27, 2006

(54) Body harness apparatus

(75) Inventor: Michael J. Millard, Clearfield, UT (US)

Correspondence Address: STOEL RIVES LLP - SLC, 201 SOUTH MAIN STREET, ONE UTAH CENTER, SALT LAKE CITY, UT, 84111, US

(73) Assignee: MJM Restraints LLC, Clearfield, UT (US)

(21) Appl. No.: 11/339,586

(22) Filed: Jan. 25, 2006

Related U.S. Application Data
(60) Provisional application No. 60/646,671, filed on Jan. 25, 2005.

(51) Int. Cl. A62B 35/00

(52) U.S. Cl. 297/466

(57) ABSTRACT

A body restraint apparatus includes first and second torso straps each having first and second ends, a first strap adjustment device coupled to the first torso strap, and a second strap adjustment device coupled to the second torso strap. The apparatus further includes a first connecting strap coupled to the first strap adjustment device and to a first connector, and a second connecting strap coupled to the second strap adjustment device and to a second connector. The apparatus further includes a main ring coupled to the second ends of the first and second torso straps, and a first ring coupled to the first torso strap between the main ring and the first adjustment device.

### RELATED APPLICATIONS

This application claims the benefit under 35 U.S.C. §119(e) of U.S. Provisional Patent Application No. 60/646,671, filed Jan. 25, 2005, and titled “Body Harness Apparatus,” which is incorporated herein by specific reference.

### TECHNICAL FIELD

The present invention relates to restraint devices for law enforcement and military applications.

### BRIEF DESCRIPTION OF THE DRAWINGS

A more particular description of the invention briefly described above will be rendered by reference to the appended drawings. Understanding that these drawings only provide information concerning typical embodiments of the invention and are not therefore to be considered limiting of its scope, the invention will be described and explained with additional specificity and detail through the use of the accompanying drawings, in which:

FIG. 1 is a plan view of one embodiment of a body harness.

FIG. 2 is a plan view of one embodiment of an assembled body harness.

FIG. 3 is a plan view of embodiments of an ankle strap apparatus, safety strap apparatus, and wrist strap apparatus that augment the body harness apparatus of FIGS. 1 and 2.

FIG. 4 is a plan drawing of one embodiment of a cover for shielding from the sun the body harness apparatus of FIGS. 1, 2, and 3.

FIG. 5 is a perspective drawing of a captive secured out of a vehicle with the ankle and wrist straps apparatuses of FIG. 3.

FIG. 6 is a perspective drawing of a captive secured inside the back seat of a vehicle with the embodiments of the body harness and straps of FIGS. 1, 2, and 3.

FIGS. 7A and 7B are perspective drawings of an embodiment of the body harness of FIGS. 1 and 2, deployed in a front seat of a vehicle.

### DETAILED DESCRIPTION OF PREFERRED EMBODIMENTS

The embodiments of this disclosure will be best understood by reference to the drawings, wherein like parts are designated by like numerals throughout. It will be readily understood that the components of the embodiments, as generally described and illustrated in the Figures herein, could be arranged and designed in a wide variety of different configurations. Thus, the following more detailed description of various embodiments, as represented in the Figures, is not intended to limit the scope of the invention, as claimed, but is merely representative of various embodiments. While the various aspects of the embodiments are presented in drawings, the drawings are not necessarily drawn to scale unless specifically indicated. In addition, the steps of a method do not necessarily need to be executed in any specific order or even sequentially, unless otherwise specified or required for proper deployment of certain embodiments of a body harness apparatus.

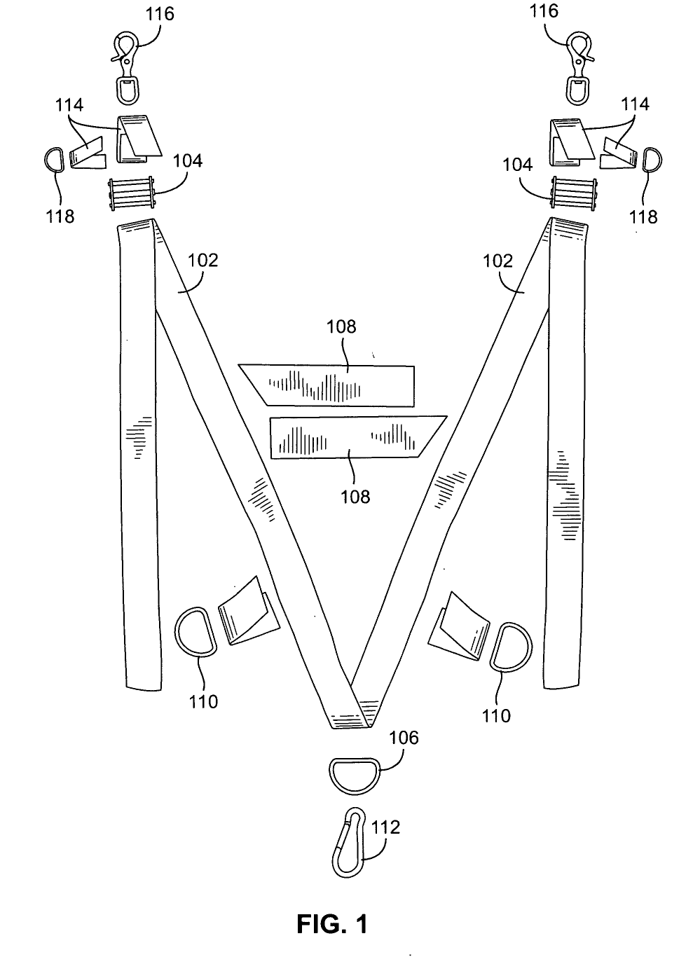

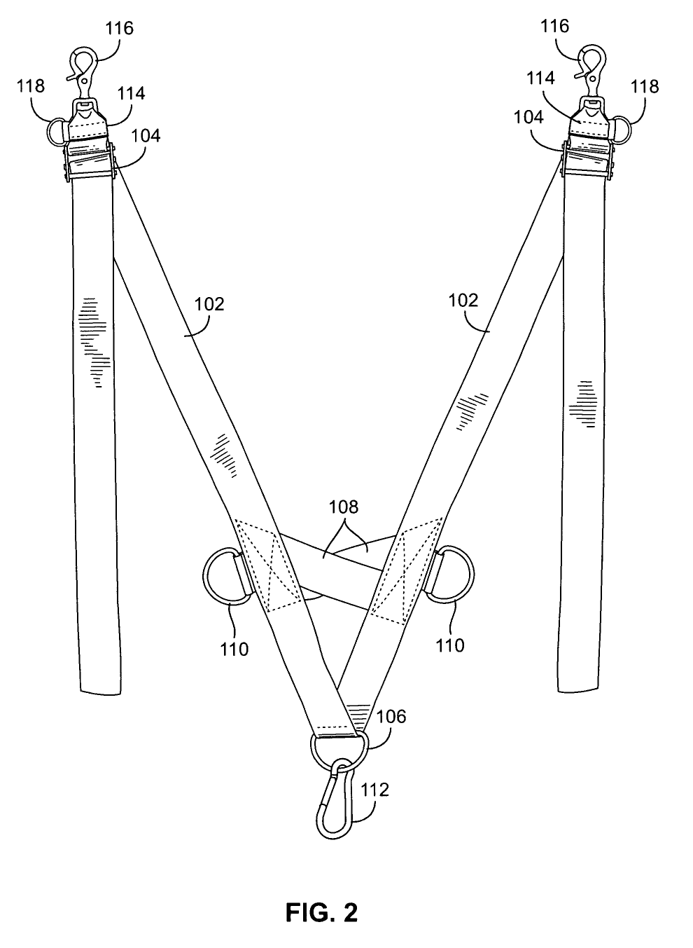

FIG. 1 illustrates a body harness 100 used to strap combative captives in a vehicle in a sitting position to help avoid the possibility of positional asphyxiation. FIG. 2 illustrates the same embodiment of the body harness 100, but as assembled. The body harness 100 may be especially useful when a captive is inebriated or incoherent, so that the captive remains in an upright position. The harness also prevents a captive from injuring him or herself, from harming others, and helps prevents the captive from getting out from under a seatbelt. Preferably, the harness is used in the center of the rear seat but could be used in either side of the rear seat, the front seat, or a bucket seat. The only seat requirement is that the seat should have a seatbelt, which will ratchet back into a locked position after having been pulled out all the way. The harness will not replace the seatbelt; it will utilize it and enhance it. The harness may include webbing. Handcuffs are also required. Shackles are optional.

The harness comprises two main torso straps 102, which extend from the waist to the shoulder. The straps 102 may also be formed from one long piece of polypropylene webbing, or similar material having similar utility. Two-inch polypropylene webbing may be used, and may be heavy-duty to withstand hundreds of pounds of pressure from a captive. Two-inch webbing has been found to minimize constriction of blood flow of a captive. Other straps as referred to herein may also be made of similar polypropylene webbing. Use of a webbing material varying in strength and thickness may fall within the scope and spirit of this disclosure so long as providing an equivalent function for which the webbing material herein described is intended, e.g., for restraint and support of a captive.

The torso straps 102 may be measured long enough to leave slack so the top ends can be pulled through a set of strap adjustment devices 104 to adjust for tightness. Thus, the strap adjustment devices 104 are coupled to the torso straps 102 such that the torso straps 102 may slide through the strap adjustment devices 104 for tightening. The strap adjustment devices 104 may include cinch rings, buckles, or other such adjustable devices known in the art.

The bottom end of each torso strap 102 is threaded through a main ring 106, folded back, and sewn into place. If a single webbing piece is used to form the straps 102, then the main ring 106 is threaded to approximately the center of the single webbing and sewn in place. Whenever a “strap” or the like is referred to herein as being coupled, connected, or attached to a connector or adjustment device of some kind, that strap may be attached by being threaded through the device, folded back onto itself, and being sewn to itself. Exceptions to this method will be noted. Any method known in the art for sewing polypropylene webbing (or similar material) may be employed, so long as the attached connection is secure and can withstand the pounds per square inch (psi) required for the applications of restraint and support.

Two cross members 108 may be sewn onto the two torso straps 102, forming an X, and joining the two torso straps together, thus preventing the separation of the torso straps 102 at a V formed where the torso straps 102 connect. At least one ring 110 may be attached to at least one torso strap 102, or a ring 110 may be attached to both torso straps 102. The ring 110 may be attached at or near the connection of the two cross members 108, or in another place suitable for its purpose, as will be discussed later. Rings 106 and 110 may be circular, D-rings, or an equivalent. A snap connector 112 may be coupled or attached to the main ring 106. The snap connector 112 may be a carabineer, or like device. One of skill in the art will appreciate that an embodiment could be designed so that the snap connector 112 replaces the main ring 106, thus functioning as both.

Two connecting anchor straps 114 (hereinafter “connecting straps”) may be used, each of which may be made of the same material as the torso straps 102. The connecting straps 114 may each be coupled to a connector device 116 (hereinafter “connector”). Connectors 116 may include quick snaps, thumb snaps, trigger snap swivels, or other such connectors. Each connector 116 may include a twistable ring attached to the bottom to provide angular mobility and a place through which each connecting strap 114 may be attached. Each strap adjustment device 104 may be coupled to the other end of each connecting strap 114. Each connecting strap 114 may be coupled to a connector 116 and ,a strap adjustment device 104 so that the latter devices, 104 and 116, are about two to four inches apart. This arrangement provides an anchor to the upper ends of the torso straps 102. Finally, one or more safety rings 118 may be coupled to the connecting straps 114, for a purpose that will be discussed later. Safety rings 118 may also be circular, D-rings, or an equivalent.

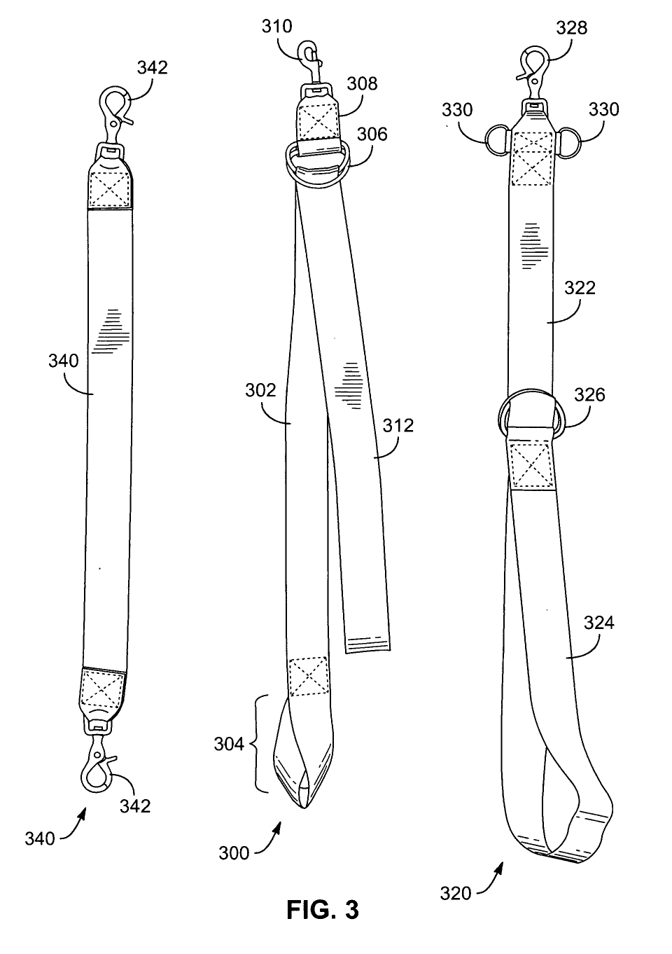

FIG. 3 displays three auxiliary strap apparatuses that may be employed with the body harness apparatus 100 to aid the body harness 100 in keeping a captive restrained and in an upright position. A wrist strap apparatus 300 may aid in keeping a captive's wrists or arms securely behind the captive's back when in handcuffs, to prevent mobility of the captive's hands. This also prevents the captive from moving his or her hands underneath the captive's legs to the front of the captive's body. The wrist strap apparatus 300 may include a wrist strap 302 made of a long piece of webbing. The webbing may be made of the same or similar material as the torso straps 102.

The wrist strap 302 may include a loop 304 at one end, which may be created by folding the strap 302 over and twisting one half turn before sewing the strap 302 onto itself. The other end of the strap may be threaded through a wrist strap adjustment device 306, which may be chosen from among similar strap adjustment devices 104 as referred to with reference to the body harness 100. An anchor connecting strap 308 may be further included, which may be connected to a connector 310. The connecting strap 308 may be coupled to the connector 310, and may further be coupled to the wrist strap adjustment device 306. The connector 310 of the wrist strap apparatus 300 may be connectable to at least one of the rings 110 coupled to the torso straps 102. In deploying the wrist strap apparatus 300, a free end 312 of the wrist strap 302 will vary in length.

An ankle strap apparatus 320, shown in FIG. 3, may also aid the body harness apparatus 100 in restraining the feet and thus the lower body of a captive. An ankle strap apparatus 320 may also keep a captive's knees bent, thus aiding in the captive remaining upright. An ankle strap apparatus 320 may include an ankle strap 322 made of a long piece of polypropylene webbing, similar to that used for the torso straps 102.

One end of the ankle strap 322 may be formed into an adjustable loop 324 through coupling the ankle strap 322 to an ankle strap adjustment device 326. An ankle strap adjustment device 326 may be chosen from among similar strap adjustment devices 104 as referred to with reference to the body harness 100. The adjustable loop 324 will allow tightening of the loop 324 about the ankles of a captive. Coupled to the other end of the ankle strap 322 may include a device connector 328, which is connectable to either the snap connector 112, or to the connector 310 of the wrist strap 302, depending on the application. The ankle strap 322 may also include one or more securement rings 330, as displayed, to which the connector 310 of the wrist strap 302 may also be connected.

A safety strap 340, shown in FIG. 3, may also aid the body harness 100 in preventing downward movement by a captive by immobilizing his or her shoulder. The body harness 100 typically holds the captive tight enough against the seat so he or she will not be able to move. On the outside chance that a wiry captive is able to slide down under the seatbelt, the safety strap 340 may be used to provide upward restraint. The safety strap 340 may be made of similar webbing material as the torso straps 102, and may have connectors 342 coupled to opposing ends. The strap may be lopped under the armpit of the captive's shoulder (usually) opposite the shoulder restrained by a seatbelt, and the connectors 342 connected to the safety rings 118 at the top of the torso straps 102.

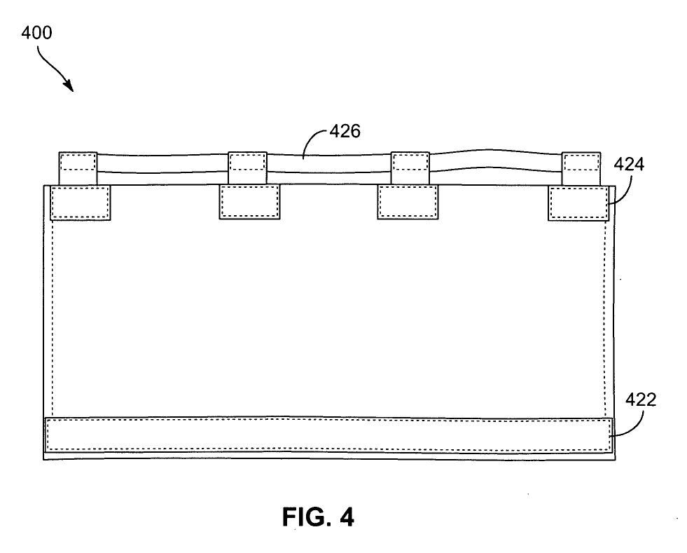

FIG. 4 displays a body harness 100 cover 400, which may be made of acrylic, or another similar material that can shield the body harness 100 from the sun. Often law enforcement personnel will leave the body harness 100 connected to the back deck of a vehicle for ready restraint of a captive. In sunny areas of the country, the metal connector parts of the body harness 100 heat up quickly if left in the sun and could potentially burn a captive, especially if the captive is not wearing a shirt. The cover 400 may be laid like a blanket over the body harness 100 and also over the other strap apparatuses 300, 320, and 340 if left on the back deck of a vehicle. The cover 400 may include a Velcro® strap 422 that may adhere to the carpet covering the back deck. Smaller Velcro® tabs 424 may be used in the front of the cover to make it easier for the front to be removed from the back deck for access to the body harness 100. A handle 426 may also be attached to the cover 400 to facilitate lifting the cover off the back deck and for carrying purposes.

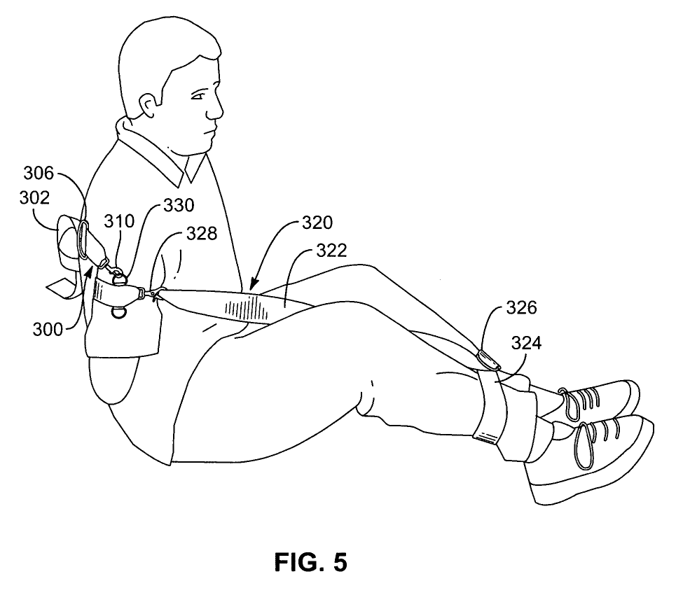

FIG. 5 displays how a captive may be restrained when outside of a vehicle using the ankle strap apparatus 320 and the wrist strap apparatus 300. While not mandatory, the process of restraining a captive in this manner is best begun while the captive is in the prone position, face down. The loop 324 of the ankle strap 322 is loosened and placed over the ankles of a captive. If shackles are used on the captive, the loop 324 should be placed above the shackles. The loop 324 may be tightened about the ankles through the ankle strap adjustment device 326 so that the captive's feet are retained together. The ankle strap 322 may then be wrapped down between the feet and back up between the legs of the captive. The ankle strap 322 may be wrapped additional times around the ankles of the captive through the captive's legs if the ankle strap 322 is being placed on a short captive and slack needs to be taken in.

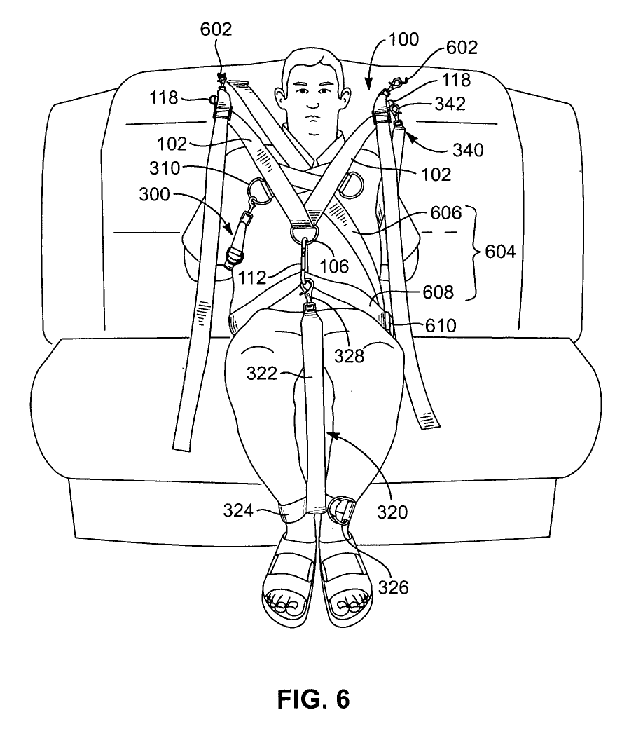

Next, the connector 310 of the wrist strap apparatus 300 may be fed through the loop end 304 of the wrist strap 302 around a captive's upper arm, forming a tightened loop. If the captive is to be later put into a vehicle, the arm so tied by the wrist strap 302 may be the arm that will be closest to a seatbelt latch 610, shown in FIG. 6. The captive may then be helped to his or her side as the ankle strap 322 is looped around the opposite upper arm from that tied by the wrist strap 302. The connection device 328 is connected back onto the ankle strap 322 itself to secure the ankle strap to that (opposite) upper arm.

The captive may be helped to a seated position, and the connector 310 of the wrist strap apparatus 300 may then be connected to the connector 328 of the ankle strap apparatus 320, or if present, to a securement ring 330. The loose wrist strap end 312 may be pulled tight through the wrist strap adjustment device 306, thus pulling the captive's elbows toward each other. This will prevent a captive from working his or her handcuffed hands underneath the captive's legs and to the front of his or her body. Finally, the loose end 308 of the wrist strap 302 may be used to tie a slip knot or similar knot to the tightened wrist strap 302.

The deployment of apparatuses 300 and 320 on a captive outside of a vehicle should also leave the captive with at least some bend in the knees, and in a sitting, upright position, as displayed. This will help prevent positional asphyxiation just as use of the body harness 100 inside a vehicle will. Such a deployment will also have the captive prepared for transfer into a vehicle and connection into a body harness 100.

FIG. 6 shows how a captive may be restrained when inside of a vehicle using a body harness 100 and strap apparatuses 300, 320, and 340 discussed in FIG. 3. For best results in applying the body harness 100, the captive may be placed in the center of a seat of the vehicle. The seat includes two anchor rings 602 used for child seat restraints. Some vehicles may be equipped with three anchor rings 602. The two torso straps 102 may be clipped to two of these anchor rings 602 to position the captive in the desired back seat.

Before placing the captive in the vehicle, the wrist strap apparatus 300 should be applied, in contrast to the application of FIG. 5, to the captive's wrist—not the upper arm. If the wrist strap apparatus 300 was previously applied to the upper arm, the wrist strap adjustment device 306 may be loosened, and the wrist strap 302 shifted to the captive's wrist. The other connectable end of the wrist strap apparatus 300 should be wrapped around the captive's side opposite from the wrist on which the wrist strap 302 has been applied. The captive should be placed in the vehicle, and the seatbelt 604 should be applied. After attaching the seatbelt 604, the shoulder belt 606 should be pulled out all the way until it clicks and then allowed to retract. The retractor should make a ratcheting sound. The seatbelt 604 is pulled tight, but not over-tightened. The seatbelt 604 should remain locked in place until the seatbelt 604 is removed.

The body harness 100 is then placed over the head of the captive, and the snap connector 112 is attached to the lap belt 608 of the seatbelt 604. When the harness 100 is on, the wrist strap 302 connector 310 should be on the captive's side opposite the captive's tied wrist. The torso straps 102 should be pulled as tight as possible through the strap adjustment devices 104, but not over-tightened. The connection device 116 of the wrist strap apparatus 300 may then be connected to a ring 110 attached to at least one of the torso straps 102. The wrist strap 302 may then be tightened by pulling the free end 312 through the wrist strap adjustment device 306. The free end 312 of the wrist strap 302 may be used to tie a slip knot or other knot around the tightened wrist strap 302 portion.

As discussed, the restraint of the captive may be augmented with a safety strap 340. The safety strap 340 may be looped under the armpit of the captive's shoulder opposite the shoulder restrained by the shoulder strap 606 of the seatbelt 604, and connected with both connectors 342 to a safety ring 118 of the harness 100. This will help provide upward restraint of the upper body of a captive, preventing downward movement and any chance that a wiry captive may work his or her way free.

As discussed, the restraint of the captive may be augmented with the ankle strap apparatus 320. The ankle strap apparatus 320 may be applied if not already applied in an outside-the-vehicle setting. If the ankle strap apparatus 320 is applied in the vehicle, the loop 324 of the ankle strap 322 is loosened and engages the ankles of the captive. The loop 324 is tightened through the ankle strap adjustment device 326 until the captive's feet are together. The ankle strap 322 may then be wrapped down through the feet of the captive and up through his or her legs. The ankle strap 322 may be wrapped more than once if needed to rein in slack of the ankle strap. The connector 328 of the ankle strap apparatus 320 may then be connected to the snap connector 112, which was previously connected to the lap belt 608 of the seatbelt 604. The captive is now prepared for safe, upright transport to another location.

Note that the connector 328 of the ankle strap apparatus 320 may be attached to a vehicle in several ways. Connector 328 may also be threaded under the front passenger seat of the vehicle and attached to the seat forward and backward adjuster bar. If the vehicle is equipped with a cage, the connector 328 can be wrapped round the bottom of the roll cage support bar and pulled back to be clipped back onto the strap between the feet. The connector 328, however, should not be placed in an area where the captive can access it with his or her feet to possibly disconnect it.

To remove the captive from the vehicle, simply release the seatbelt latch 610. Releasing the seatbelt latch 610 provides enough slack in the harness 100 to release the torso strap 102 from the inside anchor ring 602 in the back deck of the vehicle. The connector 116 of the wrist strap apparatus 300 is disconnected from the ring 110 of the harness 100. The wrist strap apparatus 300 may remain on the captive until the captive is taken inside the jail or police station. The connector 328 of the ankle strap apparatus 320 is disconnected from the snap connector 112 (or other structure in the vehicle). Once these four disconnections are made, the seatbelt 604 releases back and allows the captive to be removed from the vehicle. The captive can be unclipped from the vehicle in as little as three seconds with this method.

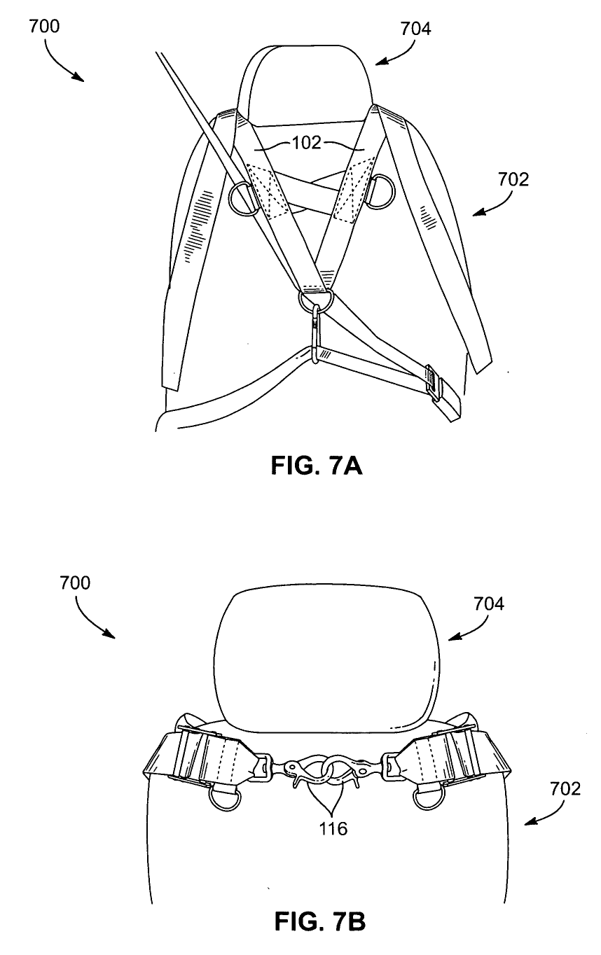

FIG. 7A displays an embodiment 700 of the body harness of FIGS. 1 and 2, deployed in a front seat 702. The torso straps 102 may be wrapped around the headrest 704 of the front seat 702 or around the upper portion of a bucket seat or other such front seat 702. FIG. 7B shows the torso strap connectors 116 being connected to each other behind the headrest 704. The torso straps 102 may then be tightened through the strap adjustment devices 104, as before. The remainder of the steps to restrain a captive in the front seat 702 of the vehicle do not vary from those already discussed in FIG. 6 for a back seat.

The terms and descriptions used herein are set forth by way of illustration only and are not meant as limitations. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense unless otherwise indicated.

1. A restraint apparatus, comprising:
first and second torso straps each having first and second ends;
a first strap adjustment device coupled to the first torso strap;
a second strap adjustment device coupled to the second torso strap;
a first connecting strap coupled to the first strap adjustment device and to a first connector;
a second connecting strap coupled to the second strap adjustment device and to a second connector;
a main ring coupled to the second ends of the first and second torso straps; and
a first ring coupled to the first torso strap between the main ring and the first adjustment device.

2. The apparatus of claim 1, further comprising a second ring coupled to the second torso strap between the main ring and the second adjustment device.

3. The apparatus of claim 2, further comprising a snap connector coupled to the main ring.

4. The apparatus of claim 1, further comprising first and second lateral straps coupled to the first and second torso straps.

5. The apparatus of claim 2, wherein the straps comprise two-inch webbing material.

6. The apparatus of claim 1, further comprising a cover to shield the restraint apparatus from sunlight.

7. The apparatus of claim 1, further including a wrist strap assembly comprising:
a wrist strap adjustment device;
a third connecting strap coupled to the wrist strap adjustment device;
a third connector coupled to the connecting strap, the third connector connectable to the first ring; and
a wrist strap having a loop at a first end and coupled to the wrist strap adjustment device.

8. The apparatus of claim 7, wherein the straps comprise two-inch webbing material.

9. The apparatus of claim 1, further including an ankle strap assembly comprising:
an ankle strap adjustment device; and
an ankle strap having first and second ends, the first end coupled to the ankle strap adjustment device to form an adjustable loop, the second end coupled to a third connector, which is connectable to the snap connector.

10. The apparatus of claim 9, wherein the ankle strap comprises two-inch webbing material.

11. The apparatus of claim 1, further comprising:
a first safety ring coupled to the first connecting strap; and
a second safety ring coupled to the second connecting strap.

12. The apparatus of claim 11, further comprising a safety strap having a third connector at a first end and a fourth connector at a second end, each third and fourth connectors connectable to one of the first and second safety rings.

13. The apparatus of claim 12, wherein the safety strap comprises two-inch webbing material.

14. A restraint apparatus, comprising:
first and second torso straps each having first and second ends;
a first strap adjustment device coupled to the first torso strap;
a second strap adjustment device coupled to the second torso strap;
a first connecting strap coupled to the first strap adjustment device and to a first connector;
a second connecting strap coupled to the second strap adjustment device and to a second connector;
a main ring coupled to the second ends of the first and second torso straps;
a first ring coupled to the first torso strap between the main ring and the first strap adjustment device;
a second ring coupled to the second torso strap between the main ring and the second strap adjustment device;
a third connector coupled to the main ring;
an adjustable wrist strap having first and second ends, the wrist strap having a loop at the first end and a fourth connector at the second end, the second end connectable to one of the first and second rings; and
an ankle strap having first and second ends, the ankle strap having an adjustable loop at the first end and a fifth connector at the second end, the second end connectable to the third connector.

15. The apparatus of claim 14, further comprising:
a first safety ring coupled to the first adjustment device; and
a second safety ring coupled to the second adjustment device.

16. The apparatus of claim 15, further comprising a safety strap having a sixth connector at a first end and a seventh connector at a second end, each sixth and seventh connectors connectable to one of the first and second safety rings.

17. The apparatus of claim 14, further comprising a cover to shield the restraint apparatus from view.

18. A restraint apparatus, comprising:
a first strap adjustment device; and
an ankle strap having first and second ends, the first end coupled to the strap adjustment device to form an adjustable loop, the second end coupled to a first connector, the first connector configured to connect onto the ankle strap around an arm of a captive, forming a second loop around the arm.

19. The apparatus of claim 18, further comprising a pair of securement rings coupled to the second end of the ankle strap.

20. The apparatus of claim 19, further comprising:
a second strap adjustment device;
a connecting strap coupled to the second strap adjustment device and to a second connector, the second connector connectable to the securement rings; and
a wrist strap having first and second ends, the first end forming a loop and the second end coupled to the second strap adjustment device.

21. The apparatus of claim 20, wherein the second connector is connectable to the first connector.

22. A method for field restraint, the method comprising:
attaching a loop end of an ankle strap to the ankles of a captive;
tightening the loop end around the ankles of the captive;
attaching a loop end of a wrist strap around an upper second arm of the captive;
looping a connectable end of the ankle strap around an upper first arm of a captive;
attaching the connectable end of the ankle strap back onto the ankle strap;
attaching a connectable end of the wrist strap to the connectable end of the ankle strap; and
tightening the wrist strap with a strap adjustment device coupled to the connectable end of the wrist strap.

23. The method of claim 22, further comprising after tightening the loop end of the ankle strap around the ankles of the captive, wrapping the ankle strap around the loop end between the ankles of the captive.

24. A method for restraint in a vehicle, the method comprising:
attaching a first end of a first torso strap of a body harness to a first seat restraint;
attaching a first end of a second torso strap of the body harness to a second seat restraint;
attaching a first loop end of a wrist strap around a wrist on a first side of a captive;
wrapping the wrist strap around a second side of the captive;
positioning the captive between the first and second attached ends;
buckling a seatbelt around the captive;
positioning the body harness so that the head of the captive is between the first and second torso straps;
attaching a snap connector coupled to the second ends of the first and second torso straps to the lap belt of the seatbelt;
tightening the first torso strap through a first strap adjustment device coupled to the first end of the first torso strap;
tightening the second torso strap through a second strap adjustment device coupled to the first end of the second torso strap;
attaching a second end of the wrist strap to a ring coupled to at least one of the first and second torso straps; and
tightening the wrist strap through a third strap adjustment device coupled to the wrist strap.

25. The method of claim 24, further comprising:
attaching a first loop end of an ankle strap to the ankles of the captive;
tightening the first loop end around the ankles of the captive through a fourth strap adjustment device coupled to the ankle strap;
wrapping the ankle strap between the feet and up through the legs of the captive; and
attaching a second end of the ankle strap to the snap connector.

26. The method of claim 25, further comprising wrapping the ankle strap additional times between the ankles of the captive to take in slack of the ankle strap.

27. The method of claim 25, wherein the second end of the ankle strap is attached to a secured structure of the vehicle.

28. The method of claim 24, further comprising attaching a safety strap having opposing connectable ends under the armpit of the captive and to a safety ring coupled to the first end of the torso strap on the first side of the captive, to restrain the shoulder of the captive in an upwards direction.

29. The method of claim 24, wherein the first ends of the first and second torso straps are interconnected behind a headrest or an upper portion of a front seat.
